(19) United States
(12) Patent Application Publication
(10) Pub. No.: US 2015/0095106 A1
(43) Pub. Date: Apr. 2, 2015

(54) Customer Relationship Management (CRM) System Having a Rules Engine for Processing Sales Program Rules

(71) Applicant: EMC Corporation, Hopkinton, MA (US)

(72) Inventor: Santosh Vaidyanathan, Bangalore (IN)

(21) Appl. No.: 14/091,493

(22) Filed: Nov. 27, 2013

(30) Foreign Application Priority Data
Sep. 30, 2013 (IN) 4442/CHE/2013

(51) Int. Cl. G06Q 30/02; H04L 12/24

(52) U.S. Cl. CPC G06Q 30/0201; H04L 41/22
USPC 705/7.29

(57) ABSTRACT

A CRM system is provided having a rules engine to process sales program rules. One or more sales programs are processed in a CRM system by obtaining one or more sales program rules defining the one or more sales programs; and applying the one or more sales program rules to a rules engine in the CRM system to determine if the one or more sales programs are applicable by accessing one or more of enterprise data and external commercial data. The sales program rules are optionally entered into the rules engine using a graphical user interface. The sales program rules can also be updated using the graphical user interface. The sales program rules comprise, for example, time-based conditions to enforce time restrictions of a given sales program and/or one or more collaborative filters.

### FIELD

The field relates generally to the processing of sales programs in a customer relationship management (CRM) system.

### BACKGROUND

Customer relationship management (CRM) is a model for managing the interactions of an enterprise with current and potential customers. A CRM tool typically employs technology to organize, automate, and synchronize sales, marketing, customer service, and technical support. CRM systems for marketing, for example, track and measure marketing campaigns over multiple channels, such as email, search, social media, telephone and direct mail. A CRM marketing system typically tracks clicks, responses, leads and deals. Salesforce.com, for example, provides a popular CRM service. CRM tools, such as Salesforce.com, typically provide functions to improve sales effectiveness using Lead, Activity, Contact and Opportunity Management tools.

Sales programs in many enterprises are purpose-built for making sales more effective by offering innovative deals or special offers and ways to penetrate a given market with its ever changing demands. Sales programs or special offers are generally time-bound, such that they are offered for a limited time. Sales programs are typically run using various reports that are extracted from multiple systems that provide information about, for example, Leads, Opportunities, Configurations, Quotes, Install Base, Inventory and Market Research. This information is analyzed to understand the current needs for a program that will provide a positive impact on sales and to design a program or special offering for a specific need. There are often multiple programs designed in parallel to target specific needs. Each program has a distinct set of rules and generally include some kind of monetary impact. It is desirable to “document, track and monitor” the activity of each of these programs to understand, analyze and quantify the value of these programs to the enterprise.

While a CRM tool and a Sales Program within an enterprise share a common goal of making sales more effective, existing enterprise CRM tools and Sales Programs are distinct tools that are not integrated with one another. Thus, the management, tracking and calculations of sales programs must be done manually using general-purpose business applications, such as Microsoft Excel and Powerpoint.

A need therefore exists for improved CRM tools that may be integrated and linked with a Sales Program within an enterprise. A further need exists for a standard and consistent process within a CRM tool to collect data and generate intelligence on sales programs.

### SUMMARY

Illustrative embodiments of the present invention provide a CRM system having a rules engine to process sales program rules. In one exemplary embodiment, one or more sales programs are processed in a CRM system by obtaining one or more sales program rules defining the one or more sales programs; and applying the one or more sales program rules to a rules engine in the CRM system to determine if the one or more sales programs are applicable by accessing one or more of enterprise data and external commercial data.

The sales program rules are optionally entered into the rules engine using a graphical user interface. The sales program rules can also be updated using the graphical user interface. The enterprise data comprises, for example, sales representative, lead and opportunity data; price quote and configuration data; install base; order information and/or additional information.

The sales program rules comprise, for example, time-based conditions to enforce time restrictions of a given sales program and/or one or more collaborative filters.

As noted above, illustrative embodiments described herein provide significant improvements relative to conventional CRM arrangements. In some of these embodiments, use of a rules engine in a CRM system allows sales program rules to be processed directly in the data rich CRM environment, thereby allowing greater integration of the sales program with the CRM data.

### BRIEF DESCRIPTION OF THE DRAWINGS

FIG. 1 illustrates a CRM system that incorporates aspects of the present invention;

FIG. 2 illustrates an exemplary cost relief program rule that can be stored in the sales program rule base and implemented by the sales program rules engine of FIG. 1;

FIG. 3 illustrates an exemplary competitive displacement special incentive rule that can be stored in the sales program rule base and implemented by the sales program rules engine of FIG. 1; and

FIG. 4 illustrates the sales program rules engine 130 of FIG. 1 in further detail.

### DETAILED DESCRIPTION

Illustrative embodiments of the present invention will be described herein with reference to exemplary CRM systems and associated clients, servers, storage arrays and other processing devices. It is to be appreciated, however, that the invention is not restricted to use with the particular illustrative CRM system and device configurations shown. Accordingly, the term “CRM system” as used herein is intended to be broadly construed, so as to encompass other types of CRM systems implemented using one or more processing devices.

Aspects of the present invention provide an improved CRM tool that is integrated and linked with sales programs within an enterprise. According to another aspect of the invention, the disclosed CRM tool provides a standard and consistent process to collect data and generate intelligence on sales programs.

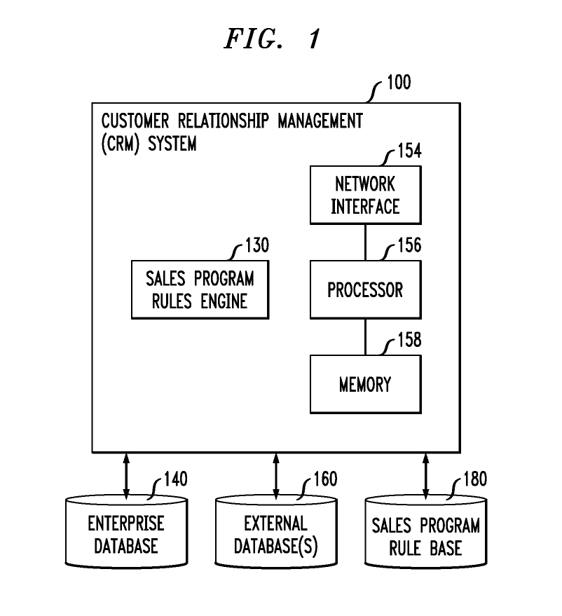

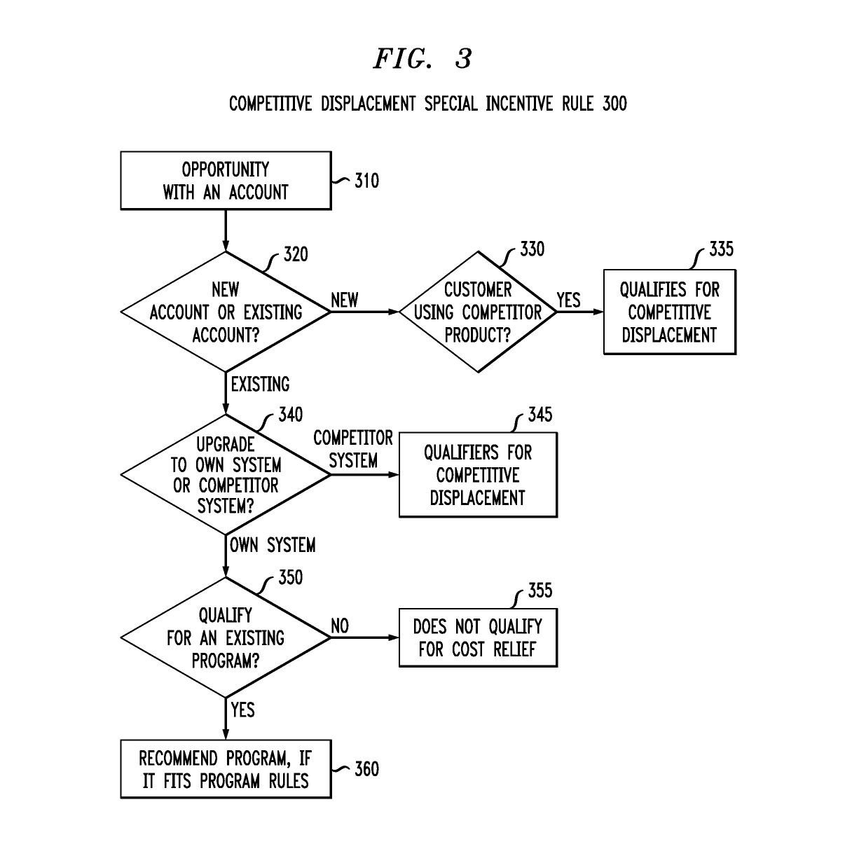

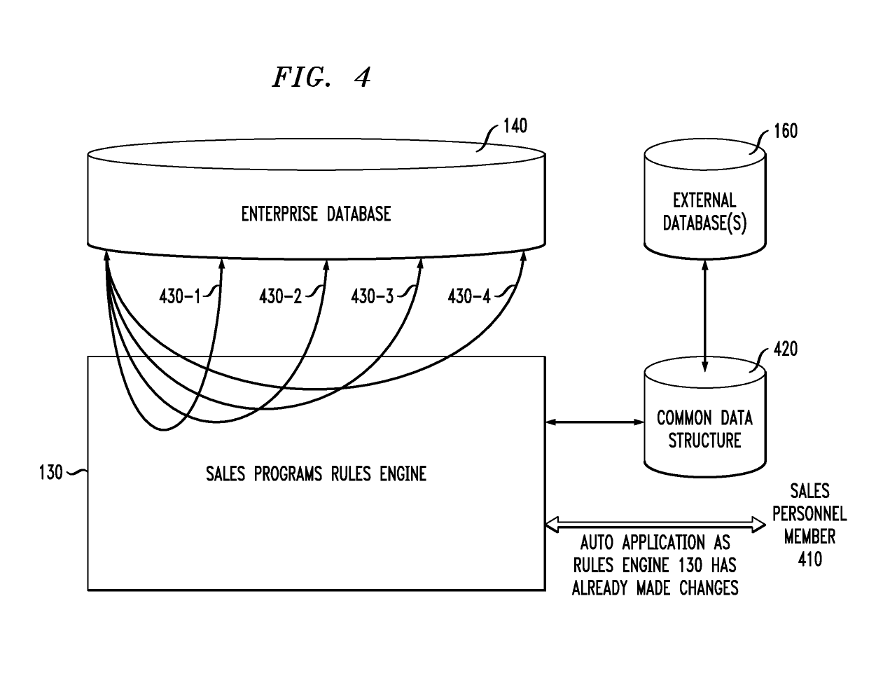

FIG. 1 illustrates a CRM system 100 that incorporates aspects of the present invention. As shown in FIG. 1, the CRM system 100 comprises a sales program rules engine 130 to implement one or more rules from a sales program rule base 180 in accordance with aspects of the present invention. The CRM system 100 may be implemented, for example, using the CRM tool from Salesforce.com. Exemplary rules from the sales program rule base 180 are discussed further below in conjunction with FIGS. 3 and 4.

The CRM system 100 may communicate with one or more enterprise database(s) 140 and/or one or more external database(s) 160 to execute the rules in the sales program rule base 180, and to subsequently create reports, manage the sales program and update the data in the enterprise database(s) 140 to report the results of a given sales program. The exemplary enterprise database(s) 140 may comprise, for example, sales representative, lead and opportunity data; price quote and configuration data; install base; order information and additional information. The exemplary external database(s) 160 may comprise, for example, commercial databases from Dun and Bradstreet and/or the Gartner Group and other sources.

For example, if a sales personnel team member (e.g., a sales representative or manager) is creating or updating a given sales program, the CRM system 100 may query one or more database(s) 140, 160 for data and information. Once the sales program is initiated, one or more database(s) 140, 160 can be automatically queried to create reports and to manage the sales program.

Generally, the rules in the sales program rule base 180 define the sales programs or special offers that are available. As indicated above, sales programs or special offers are generally time-bound, such that they are offered for a limited time. Thus, the rules in the sales program rule base 180 typically comprise time-based conditions to enforce the time restrictions. For example, a sales program or special offer may be valid for a specific time period, such as (i) until the inventory is exhausted of certain parts/configurations; (ii) for a defined introductory period; or (ii) under specific time conditions, such as until a given competitor is displaced from the customer account.

In addition, one or more rules in the sales program rule base 180 optionally comprise one or more collaborative filters to improve a sales program. Generally, a collaborative filter identifies information or patterns using techniques involving collaboration among multiple agents, viewpoints and/or data sources. Typically, collaborative filters automatically predict (filter) the interests of a user by collecting preferences or taste information from many users (collaborating). For example, “people who viewed this item also viewed . . . ” or “people who purchased this item also purchased . . . ” In general, the rules in the sales program rule base 180 employ intelligence and mapping techniques to identify sales programs that are applicable to a given scenario. Exemplary rules from the sales program rule base 180 are discussed further below in conjunction with FIGS. 3 and 4.

The CRM system 100 further comprises a processor 156 coupled to a memory 158. The processor 156 may comprise a microprocessor, a microcontroller, an application-specific integrated circuit (ASIC), a field-programmable gate array (FPGA) or other type of processing circuitry, as well as portions or combinations of such circuitry elements. The memory 158 may comprise random access memory (RAM), read-only memory (ROM) or other types of memory, in any combination. The memory 158 and other memories disclosed herein may be viewed as examples of what are more generally referred to as “computer program products” storing executable computer program code.

Also included in the CRM system 100 is network interface circuitry 154. The network interface circuitry 154 allows the CRM system 100 to communicate over a network with other processing devices. The network interface circuitry 154 may comprise, for example, one or more conventional transceivers.

The sales program rules engine 130 of the CRM system 100 may be implemented at least in part in the form of software that is stored in memory 158 and executed by processor 156. The CRM system 100 comprising processor, memory and network interface components as described above is an example of what is more generally referred to herein as a “processing device.”

Although only a single sales program rules engine 130 is shown in the FIG. 1 embodiment, a given CRM system 100 in other embodiments may comprise multiple sales program rules engines 130.

As indicated above a CRM system 100 is often used by direct sales representatives and channel partners of an enterprise to manage leads, opportunities, etc. A CRM system 100 typically has a number of tools and modules that enable sales personnel to manage the sale process.

A CRM system 100 typically provides a number of known productivity gains, such as viewing and capturing account, contact and activity information; viewing installed base and maintenance; contracts data for an account; account intelligence provided from various internal and external sources; and online collaboration with an entire sales team.

In addition, a CRM system 100 typically provides a known mechanism for effective lead management, such as enhanced collaboration through a more seamless lead hand-off process; simplified opportunity creation via leads; enhanced visibility into lead conversion; and closed loop lead tracking. A typical CRM system 100 also provides a dashboard and reporting tool offering customizable reports at all levels providing visual graphs to efficiently view data in the CRM system 100. A user can also manage Activities, such as tasks and events, using the CRM system 100, including the ability to set appointments, reminders and tasks and associate with specific contacts or accounts.

In general, the exemplary CRM system 100 provides features and tools to assist sales personnel from leads to booked orders, and optionally the ability to manage the customer service and maintenance process.

In one exemplary implementation, the CRM system 100 is embodied as the Sales Cloud from Salesforce.com. The Sales Cloud includes a real-time sales collaborative tool referred to as Chatter, that provides sales representatives with a customer profile and account history, allows the user to manage marketing campaign spending and performance across a variety of channels from a single application, tracks opportunity-related data including milestones, decision makers, customer communications, and other information unique to the company's sales process.

Sales programs are often run using various reports that are extracted from multiple systems that give information about Leads, Opportunities, Configurations, Quotes, Install Base, Inventory, Market Research etc. Such systems may or may not be integrated with the CRM system 100. The extracted information is analyzed to understand the current needs for a program that will impact sales positively and a program or special offering is designed for a specific need. As noted above, there could be multiple programs designed in parallel to target specific needs.

Currently, sales programs are tracked under different names with respective identifiers for Leads/Opportunities that qualify for a certain program. Each program generally includes some kind of monetary impact.

As noted above, conventional CRM systems manually perform management, tracking and calculations of Sales Programs.

According to one aspect of the present invention, the CRM system 100 comprises the sales program rules engine 130 to include the sales programs rules on the CRM system 100 itself. In this manner, the sales program rules engine 130 can recognize if a certain opportunity with a connected quote and configuration qualifies for a certain sales program. If a given rule is satisfied, the monetary impacts are applied on respective pricing and follow through to the order process.

According to another aspect of the present invention, the CRM system 100 provides a graphical user interface (GUI) that allows the CRM system 100 to be programmed with criteria from the sales programs with a start and an expiration date. The rules engine 130 optionally uses machine learning techniques and a self-learning agent to proactively flag more competitive programs in cases where it can be applied.

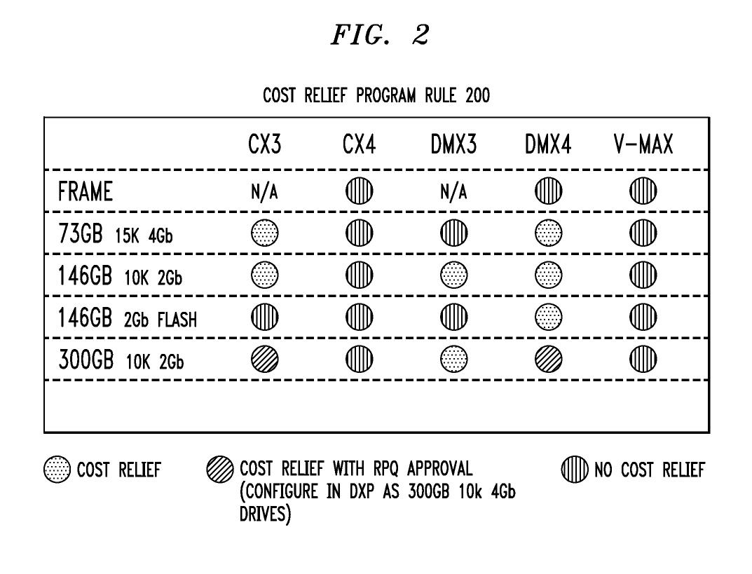

FIG. 2 illustrates an exemplary cost relief program rule 200 that can be stored in the sales program rule base 180 and implemented by the sales program rules engine 130. As shown in FIG. 2, the exemplary cost relief program rule 200 provides various levels of cost relief for various models of a storage product. When a given cost relief program is applicable to a given sale, the cost relief can improve the profit margin of the transaction and provide a sales representative with additional leverage to sell the product.

FIG. 3 illustrates an exemplary competitive displacement special incentive rule 300 that can be stored in the sales program rule base 180 and implemented by the sales program rules engine 130. As shown in FIG. 3, the exemplary competitive displacement special incentive rule 300 is initiated during step 310 with an opportunity with an account.

A test is performed during step 320, to determine if the account is a new or existing account. If it is determined during step 320 that the account is a new account, then a further test is performed during step 320, to determine if the customer is using a competitor product. If the customer is using a competitor product, then the transaction qualifies for a competitive displacement incentive during step 335.

If it is determined during step 320 that the account is an existing account, then a further test is performed during step 340, to determine if the existing customer is upgrading to a system of the same company or to a competitor system. If the existing customer is upgrading to a competitor system, then the transaction qualifies for a competitive displacement incentive during step 345.

If the existing customer is upgrading to a system of the same company, then a further test is performed during step 350, to determine if the upgrade qualifies for an existing program. If the upgrade does not qualify for an existing program, then the transaction does not qualify for a competitive displacement incentive during step 355. If the upgrade does not qualify for an existing program, then the program is recommended during step 360, if the transaction fits the program rules.

FIG. 4 illustrates the sales program rules engine 130 of FIG. 1 in further detail. As indicated above, the sales program rules engine 130 interacts with the enterprise database(s) 140 and/or one or more external database(s) 160 to execute the rules in the sales program rule base 180, and to subsequently create reports, manage the sales program and update the data in the enterprise database(s) 140 to report the results of a given sales program.

As indicated above, the exemplary enterprise database(s) 140 comprises (i) sales representative, lead and opportunity data; (ii) price quote and configuration data; (iii) install base; (iv) order information and (v) additional information. The arrows 430-1 through 430-4 indicate the information from the various enterprise information sources being processed through the sales program rules engine 130 to process rules and to subsequently create reports, manage the sales program and update the data in the enterprise database(s) 140 to report the results of a given sales program.

The exemplary external database(s) 160 comprise commercial databases from Dun and Bradstreet and/or the Gartner Group and other sources. A common data structure 420 is optionally employed to capture such information from external sources into the CRM System 100.

The Data Model for Access Rules comprise objects, fields, and records. Likewise, The Data Model for Validation Rules comprise Calculation Rules: Triggers and Formulas.

As shown in FIG. 4, a sales personnel member 410 can interact with the Rules Engine 130, for example, to enter and update rules into the CRM system 100, for example, using a GUI. In addition, a sales personnel member 410 can automatically obtain sales accreditation for new and ongoing programs and benefits, as well as auto qualification and application of the monetary impact associated with successful sales programs.

It is to be appreciated that the particular operations and associated messaging illustrated herein are exemplary only and numerous other types of operations and messaging may be used in other embodiments.

It should therefore be understood that in other embodiments different arrangements of additional or alternative elements may be used. At least a subset of these elements may be collectively implemented on a common processing platform or each such element may be implemented on a separate processing platform.

Also, numerous other arrangements of computers, servers, storage devices or other components are possible in the CRM system 100. Such components can communicate with other elements of the CRM system 100 over any type of network or other communication media.

As indicated previously, components of a sales program rules engine 130 as disclosed herein can be implemented at least in part in the form of one or more software programs stored in memory and executed by a processor of a processing device. A memory having such program code embodied therein is an example of what is more generally referred to herein as a “computer program product.”

The CRM systems shown in FIGS. 1 and 4 or portions thereof may be implemented using one or more processing platforms each comprising a plurality of processing devices. Each such processing device may comprise processor, memory and network interface components of the type illustrated for CRM system 100 in FIG. 1.

As indicated above, CRM system functionality such as that described in conjunction with FIGS. 1 through 4 can be implemented at least in part in the form of one or more software programs stored in memory and executed by a processor of a processing device such as a computer or server. A memory or other storage device having such program code embodied therein is an example of what is more generally referred to herein as a “computer program product.” Certain system components are implemented using a combination of software and hardware.

It should again be emphasized that the above-described embodiments of the invention are presented for purposes of illustration only. Many variations and other alternative embodiments may be used. For example, the disclosed techniques are applicable to a wide variety of other types and arrangements of CRM systems and associated clients, servers and other processing devices that can benefit from sales program rules engine functionality as described herein. Also, the particular configurations of system and device elements shown in FIGS. 1 and 4 can be varied in other embodiments. Moreover, the various assumptions made above in the course of describing the illustrative embodiments should also be viewed as exemplary rather than as requirements or limitations of the invention. Numerous other alternative embodiments within the scope of the appended claims will be readily apparent to those skilled in the art.

What is claimed is:

1. A method for processing one or more sales programs in a Customer Relationship Management (CRM) system, comprising:
obtaining one or more sales program rules defining said one or more sales programs; and
applying said one or more sales program rules to a rules engine in said CRM system to determine if said one or more sales programs are applicable by accessing one or more of enterprise data and external commercial data.

2. The method of claim 1, wherein said one or more sales program rules are entered into said rules engine using a graphical user interface.

3. The method of claim 2, wherein said one or more sales program rules are updated using said graphical user interface.

4. The method of claim 1, further comprising the step of reporting data from said sales programs.

5. The method of claim 1, wherein said CRM system comprises a Salesforce.com CRM tool.

6. The method of claim 1, wherein said enterprise data comprises one or more of sales representative, lead and opportunity data; price quote and configuration data; install base; order information and additional information.

7. The method of claim 1, wherein one or more of said sales program rules comprise time-based conditions to enforce time restrictions of a given sales program.

8. The method of claim 1, wherein one or more of said sales program rules comprise one or more collaborative filters.

9. A computer program product comprising a tangible machine-readable storage medium having encoded therein executable code of one or more software programs, wherein the one or more software programs when executed cause the CRM system to perform the steps of the method of claim 1.

10. A Customer Relationship Management (CRM) system for processing one or more sales programs, comprising:
a memory configured to store one or more sales program rules defining said one or more sales programs; and
a rules engine configured to execute said one or more sales program rules to determine if said one or more sales programs are applicable by accessing one or more of enterprise data and external commercial data.

11. The system of claim 10, wherein said one or more sales program rules are entered into said rules engine using a graphical user interface.

12. The system of claim 11, wherein said one or more sales program rules are updated using said graphical user interface.

13. The system of claim 10, wherein said CRM system is further configured to report data from said sales programs.

14. The system of claim 10, wherein said CRM system comprises a Salesforce.com CRM tool.

15. The system of claim 10, wherein said enterprise data comprises one or more of sales representative, lead and opportunity data; price quote and configuration data; install base; order information and additional information.

16. The system of claim 10, wherein one or more of said sales program rules comprise time-based conditions to enforce time restrictions of a given sales program.

17. The system of claim 10, wherein one or more of said sales program rules comprise one or more collaborative filters.
